(19) United States
(12) Patent Application Publication
(10) Pub. No.: US 2024/0326280 A1
(43) Pub. Date: Oct. 3, 2024

(54) SAW CHAIN AND CHAINSAW ASSEMBLY

(71) Applicant: HANGZHOU EXCELSIOR & SHARP GARDEN TOOLS CO., LTD, Hangzhou (CN)

(72) Inventor: Quanfu WANG, Hangzhou (CN)

(21) Appl. No.: 18/733,800

(22) Filed: Jun. 4, 2024

Related U.S. Application Data
(63) Continuation of application No. PCT/CN2023/078588, filed on Feb. 28, 2023.

(30) Foreign Application Priority Data
Oct. 20, 2022 (CN) 202211284900.4

(51) Int. Cl. B27B 17/02; B27B 33/14

(52) U.S. Cl. CPC B27B 17/02; B27B 33/14

(57) ABSTRACT

A saw chain comprises a transmission sheet (2), a connecting sheet (3) and a blade (4); a friction portion (21) is arranged at a bottom portion of the transmission sheet (2); and the chainsaw assembly comprises a non-metal guide plate (1) and the saw chain, the saw chain is arranged in a guide plate slot (11) of the non-metal guide plate (1), the transmission sheet (2) is inserted into the guide plate slot (11), the friction portion (21) makes contact with and is in sliding fit with a bottom portion of the guide plate slot (11), and meanwhile, a supporting portion (31) is also arranged on the connecting sheet (3) and in sliding fit with a surface of the non-metal guide plate (1) after the bottom portion of the guide plate slot (11) generates friction loss to a specific extent with the friction portion (21).

### CROSS-REFERENCE TO RELATED APPLICATIONS

This application is a continuation of International Patent Application No. PCT/CN2023/078588 with a filing date of Feb. 28, 2023, designating the United States, now pending, and further claims priority to Chinese Patent Application No. 202211284900.4 with a filing date of Oct. 20, 2022. The content of the aforementioned applications, including any intervening amendments thereto, are incorporated herein by reference.

### TECHNICAL FIELD

The present invention relates to the technical field of chain saws, and more particularly, to a saw chain and a chainsaw assembly.

### BACKGROUND OF THE PRESENT INVENTION

Chain saw, also known as gasoline saw, is a portable saw (cutting machine) powered by a gasoline engine, which is mainly used for logging and bucking by a working principle of shearing by a transverse movement of staggered L-shaped blades on a saw chain.

A chainsaw assembly generally comprises the saw chain and a guide plate, wherein the saw chain comprises a transmission sheet, a connecting sheet and a blade; and “the Patent No. 202220055847X, titled a saw chain suitable for a lithium electric saw and a lithium electric saw”, “the Pat. No. 202110694940.5, titled an electric chain saw assembly”, “the Patent No. 2020102854011, titled a saw chain connecting sheet, a saw chain and a saw chain transmission system” and “the Pat. No. 202010256289.9, titled a saw chain for a light lithium battery” all disclose a specific structure of the chainsaw assembly.

During working, the saw chain needs to rotate around the guide plate at a high speed, so that a joint between the saw chain and the guide plate will be worn, and cutting efficiency will be affected in the case of severe wear. Therefore, in addition to the wear of the blades, the wear between the saw chain and the guide plate will also affect the service life of the whole saw chain.

Traditional guide plate and saw chain are both made of metal, and when the saw chain operates around the guide plate, it is necessary to add lubricating oil between the saw chain and the guide plate to ensure the smooth operation, reduce the wear between the guide plate and the saw chain, and reduce heat energy generated by metal friction. At that time, the lubricating oil may cause pollution, and weights of the metal guide plate and saw chain are both heavy, so that the chain saw is cumbersome and inconvenient to move and use by a user.

The development of non-metal materials (which are mainly composite materials) in the prior art has been very mature, especially the wear-resistant and high-temperature-resistant composite materials produced can all reach high-temperature-resistant and wear-resistant standards under the working environment in the present application. The development of non-metal materials (which are mainly composite materials) in the prior art has been very mature, especially the high-temperature-resistant and wear-resistant composite materials produced are mature materials that are very easy for those skilled in the art to think of and use.

For example, 1. in the Chinese patent with the Patent No. 201510738453.9, titled “a heat-resistant and wear-resistant PTFE plastic material and a preparation method thereof” and disclosed on Sep. 12, 2017, the PTFE plastic material disclosed in this patent has a thermal deformation temperature greater than 300° C.;

2. in the Chinese patent with the Patent No. 202011514390.6, titled “a heat-resistant and wear-resistant PEEK matrix composite material and a preparation method thereof” and disclosed on Dec. 21, 2020, the PEEK matrix composite material disclosed in this patent has a thermal deformation temperature as high as 310° C. to 315° C. and a long-term heat resistance index of 280° C.;

3. in the Chinese patent with the Patent No. 201910185460.9, titled “a high-temperature-resistant and wear-resistant polyimide resin and a preparation method and application thereof” and disclosed on Jul. 13, 2021, the polyimide resin disclosed in this patent has a highest temperature of 380° C. in continuous use and a highest temperature of 500° C. in a short time; and

4. in the Chinese patent with the Patent No. 202111082783.9, titled “a high-temperature-resistant and wear-resistant PEEK profile composite material and a preparation method thereof” and disclosed on Nov. 2, 2021, the PEEK profile composite material disclosed in this patent has no obvious change at 280° C., and has excellent wear resistance due to the addition of carbon fiber micropowder, glass fiber micropowder, and other components.

### SUMMARY OF THE PRESENT INVENTION

The present invention aims to solve the problems in the prior art, and to provide a saw chain and a chainsaw assembly, which can reduce pollution by lubricating oil, while guaranteeing the service life of a part between the saw chain and a guide plate.

The technical solution used in the present invention to solve the above problems is that: a saw chain is arranged on a guide plate to rotate around a periphery of the guide plate for cutting, the saw chain comprises a transmission sheet and a connecting sheet which are sequentially and rotationally connected end-to-end, and a blade located on two sides of transmission sheets, two transmission sheets are connected by the connecting sheet located on two sides of the two transmission sheets, and the transmission sheet is inserted into a guide plate slot in the periphery of the guide plate when mounting the saw chain, wherein: a friction portion in sliding fit with a slot bottom of the guide plate slot is arranged at a bottom portion of the transmission sheet.

The present invention further discloses a chainsaw assembly, which comprises a guide plate and the saw chain above, wherein the guide plate is a non-metal guide plate; and the transmission sheet is inserted into the guide plate slot in the non-metal guide plate, and the friction portion at the bottom portion of the transmission sheet makes contact with and is in sliding fit with a bottom portion of the guide plate slot of the non-metal guide plate.

Preferably, a supporting portion is arranged on the connecting sheet, the supporting portion is suspended above the non-metal guide plate, and a gap is left between the supporting portion on the connecting sheet and a surface of the non-metal guide plate during mounting; and after the bottom portion of the guide plate slot of the non-metal guide plate generates friction loss with the friction portion at the bottom portion of the transmission sheet, the transmission sheet sinks and drives the supporting portion on the connecting sheet to lean against a surface of the non-metal guide plate to be in sliding fit with the surface of the non-metal guide plate.

Preferably, a contact surface between the friction portion and a slot bottom surface of the guide plate slot is a plane or an arc surface. The arrangement of the plane or the arc surface may make the transmission sheet slide on the bottom portion of the guide plate slot more smoothly.

Preferably, chamfers are respectively arranged at two ends of the friction portion on the transmission sheet, and a radius of the chamfer is 0.1 mm to 10 mm.

Preferably, a limiting block protruding upwards is arranged at a top end of the transmission sheet, and a height of the limiting block is lower than a height of the blade. In this solution, each transmission sheet is provided with the limiting block.

Preferably, a limiting block protruding upwards is arranged at a top end of any transmission sheet connected with the same connecting sheet, and a height of the limiting block is lower than a height of the blade. Because the limiting block protruding upwards is arranged on the transmission sheet, firstly, a production procedure needs to be added, secondly, a production difficulty is increased, and thirdly, a manufacturing cost is increased, and in this solution, one of two transmission sheets connected with the same connecting sheet is provided with the limiting block, so that a manufacturing cost can be reduced, and it is unnecessary to arrange one limiting block protruding upwards on each transmission sheet. During production, it is only necessary to produce a half of transmission sheets provided with the limiting block.

Preferably, a scraper is arranged on the supporting portion on at least one connecting sheet. When the supporting portion on the bottom portion of the connecting sheet makes contact with a surface of the periphery of the guide plate to form sliding fit, the friction at the bottom portion of the guide plate slot may be too fast when the friction portion at the bottom portion of the transmission sheet is in frictional sliding fit with the slot bottom of the guide plate slot, so that only the supporting portion on the bottom portion of the connecting sheet makes contact with the surface of the periphery of the guide plate to form sliding fit, but there is no frictional sliding fit between the friction portion at the bottom portion of the transmission sheet and the bottom portion of the guide plate slot, and the arrangement of the scraper aims to scrape off the surface of the periphery of the guide plate quickly, so that the frictional sliding fit between the friction portion at the bottom portion of the transmission sheet and the bottom portion of the guide plate slot is continuously kept, thus avoiding the occurrence of the above situation.

Preferably, the connecting sheet is arranged in a structure of full central symmetry, and is in left-right and up-down consistency, wherein each lower edge is provided with a concave arc, and the scraper is arranged on an arc surface of the concave arc.

Preferably, a distance between the connecting sheet and the surface of the guide plate is 0 to 1 mm; and a depth of the guide plate slot is 3.16 mm. The present invention has the beneficial effects as follows.

In the present application, the guide plate is made of a non-metal material, and compared with a guide plate made of a metal material, the guide plate made of the non-metal material is lighter in weight, so that the chain saw is not bulky and is convenient for a user to move and use. Meanwhile, due to the characteristics of plastic material, no lubricating oil needs to be applied between the guide plate and the saw chain during operation to ensure the smooth operation of the chainsaw assembly, which also avoids the problem of pollution by the lubricating oil.

The chainsaw assembly in the present application comprises two working states.

In a first working state (also referring to an initial working state), the saw chain rotates around the periphery of the guide plate through the contact and sliding fit between the friction portion arranged at the bottom portion of the transmission sheet and the bottom portion of the guide plate slot of the non-metal guide plate, and in the first working state, the friction portion at the bottom portion of the transmission sheet forms contact friction with the non-metal guide plate as a stress point between the saw chain and the guide plate when the saw chain rotates around the periphery of the guide plate.

A second working state is started after the bottom portion of the guide plate slot of the non-metal guide plate is worn to a certain extent by the friction portion of the transmission sheet, and a slot depth of the guide plate slot is increased after the bottom portion of the guide plate slot is worn, so that the transmission sheet sinks and drives the connecting sheet connected to the transmission sheet to descend, thus making the supporting portion on the connecting sheet in sliding fit with the surface of the periphery of the guide plate, and begin to play a role of a second stress point between the saw chain and the guide plate when the saw chain rotates around the periphery of the guide plate. Therefore, the second working state in which the friction portion of the transmission sheet and the supporting portion of the connecting sheet are both in sliding fit with the guide plate is formed.

When the supporting portion is in sliding fit with the surface of the periphery of the non-metal guide plate, the friction portion still forms contact friction with the bottom portion of the guide plate slot, and because the connecting sheet is arranged on two sides of transmission sheets, the surfaces of the peripheries on the left and right sides of the non-metal guide plate may both form contact friction with the supporting portion, so that a three-side stress is formed in the second working state. The sliding friction of the supporting portion reduces a force between the friction portion and the bottom portion of the guide plate slot, so that the service time of a part between the friction portion and the bottom portion of the guide plate slot is longer.

According to the above two working states, after a bottom surface of the guide plate slot of the non-metal guide plate is worn to a certain extent in the first working state, the chainsaw assembly enters the second working state, and the supporting portion is used to relieve and bear a stress between the supporting portion and the guide plate, so that the supporting portion and the bottom surface of the guide plate slot may be used in a sliding way for a longer time, thus prolonging the service life of the chainsaw assembly.

### DESCRIPTION OF THE DRAWINGS

FIG. 1 is a schematic structural diagram of a guide plate of the present invention;

FIG. 2 is a schematic structural diagram of a side portion of the guide plate of the present invention;

FIG. 3 is a schematic structural diagram of a saw chain of the present invention;

FIG. 4 is a schematic structural diagram of a first transmission sheet of the present invention;

FIG. 5 is a schematic structural diagram of a second transmission sheet of the present invention;

FIG. 6 is a schematic structural diagram of a connecting sheet of the present invention;

FIG. 7 is a schematic structural diagram of the connecting sheet provided with a scraper of the present invention;

FIG. 8 is a schematic structural diagram of the saw chain arranged on the guide plate of the present invention;

FIG. 9 is a schematic structural diagram of the saw chain arranged on an upper side portion of the guide plate in a first working state of the present invention; and

FIG. 10 is a schematic structural diagram of the saw chain arranged on the upper side portion of the guide plate in a second working state of the present invention.

In the drawings: 1 refers to non-metal guide plate, 11 refers to guide plate slot, 2 refers to transmission sheet, 21 refers to friction portion, 22 refers to limiting block, 3 refers to connecting sheet, 31 refers to supporting portion, 32 refers to scraper, 4 refers to blade, 5 refers to chain shaft hole, and 6 refers to gap.

### DETAILED DESCRIPTION OF PREFERRED EMBODIMENTS

The present invention is further described hereinafter with reference to the drawings.

### First Embodiment

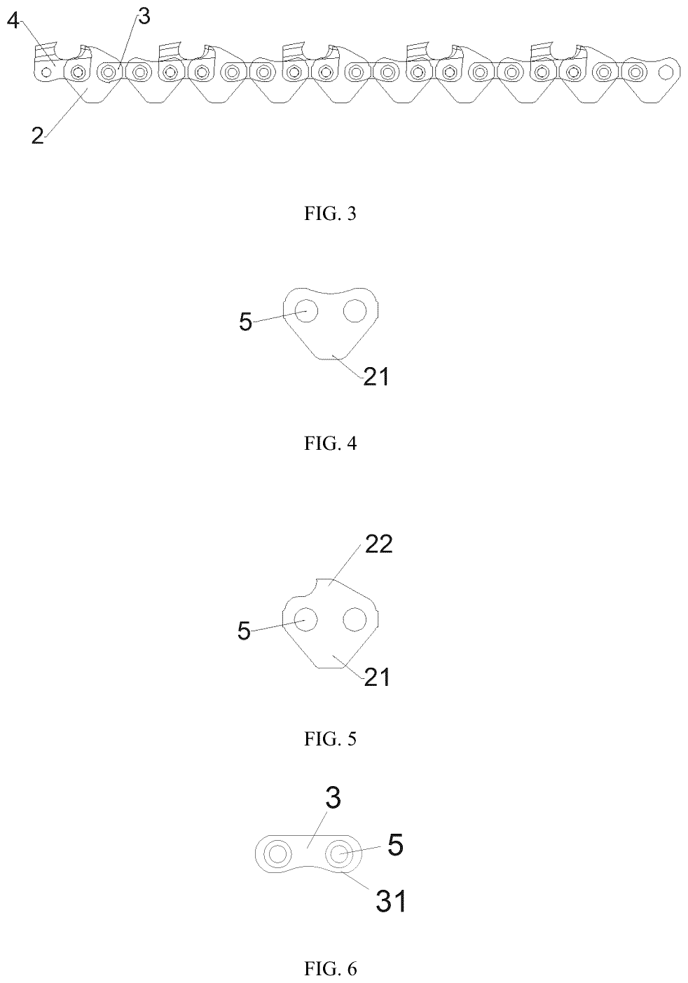

As shown in FIG. 3, this embodiment provides a saw chain, which is arranged on a guide plate to rotate around a periphery of the guide plate for cutting. The saw chain comprises a transmission sheet 2 and a connecting sheet 3 which are sequentially and rotationally connected end-to-end, and a blade 4 located on two sides of transmission sheets 1, two transmission sheets 2 are connected by the connecting sheet 3 located on two sides of the two transmission sheets, and when the saw chain is mounted on the guide plate, the transmission sheet 2 is inserted into a guide plate slot 11 in the periphery of the guide plate; wherein, a friction portion 21 in sliding fit with a slot bottom of the guide plate slot 11 is arranged at a bottom portion of the transmission sheet 2, and the saw chain rotates around the periphery of the guide plate by inserting the transmission sheet 2 into the guide plate slot and forming mutual friction between c and the guide plate slot.

### Second Embodiment

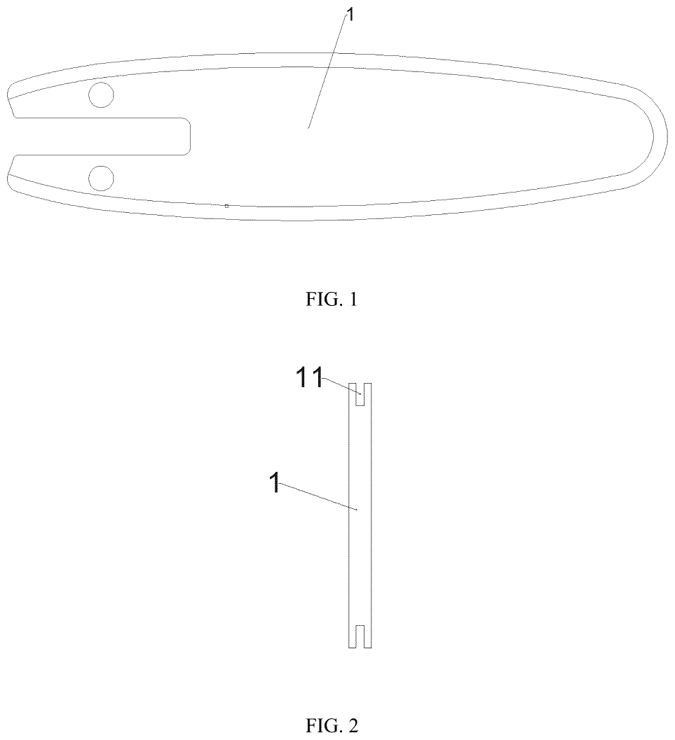

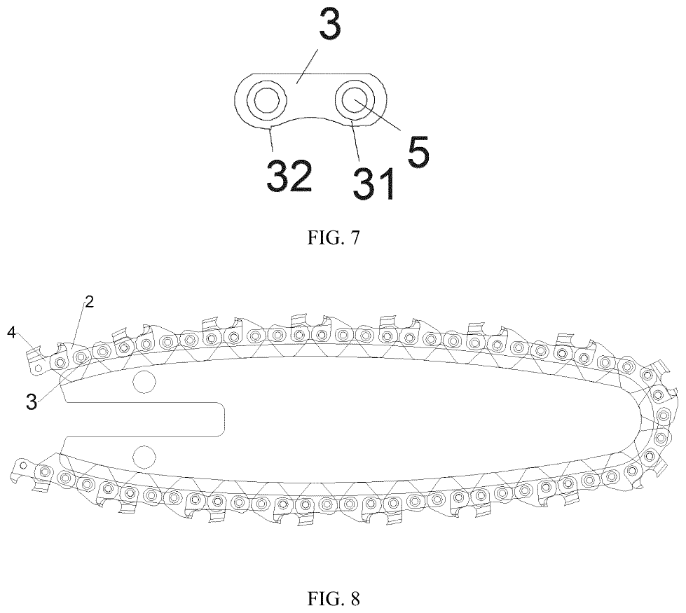

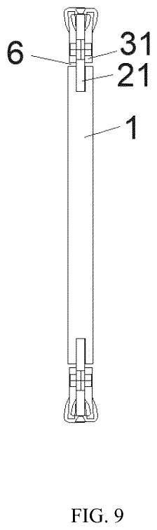

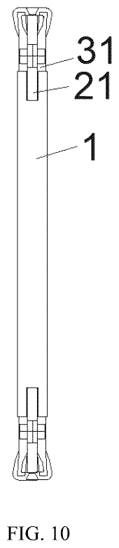

As shown in FIG. 1 to FIG. 10, this embodiment provides a chainsaw assembly, which comprises a non-metal guide plate 1 and the saw chain described in First Embodiment. A guide plate slot 11 is arranged in the non-metal guide plate 1, and the saw chain rotates around a periphery of the non-metal guide plate 1 by being arranged in the guide plate slot 11. The saw chain comprises the transmission sheet 2 and the connecting sheet 3 which are sequentially and rotationally connected end-to-end, and the blade 4 located on side portions of transmission sheets 2. The non-metal guide plate 1 is a non-metal guide plate 1 made of a non-metal material.

The transmission sheet 2 is inserted into the guide plate slot 11, the friction portion 21 is arranged at the bottom portion of the transmission sheet 2, and the friction portion 21 makes contact with and is in sliding fit with the bottom portion of the guide plate slot 11, so that the saw chain is arranged on the guide plate slot 11 and rotates around the periphery of the non-metal guide plate 1. As shown in FIG. 4, a contact surface between the friction portion 21 at the bottom portion of the transmission sheet 2 and a slot bottom surface of the guide plate slot 11 is a plane (or an arc surface), chamfers are respectively arranged at two ends of the friction portion 21, and a radius R of the chamfer is 1.00 mm. The above structural arrangement of the transmission sheet 2 aims to make mutual sliding friction between the friction portion 21 and the bottom surface of the guide plate slot 11 more smoothly, and to avoid excessive friction between the friction portion 21 and the slot bottom of the guide plate slot 11, which will make the slot bottom of the guide plate slot 11 wear too fast to affect the service life of the chainsaw assembly.

Two transmission sheets 2 are connected by the connecting sheet 3 located on two sides of the two transmission sheets, a supporting portion 31 is arranged on the connecting sheet 3, and the supporting portion 31 is suspended above the non-metal guide plate 1. Specifically, the supporting portion 31 is located on the bottom portion of the connecting sheet 3, and the connecting sheet 3 is also suspended above the non-metal guide plate 1. A gap 6 is left between the supporting portion 31 and a surface of the non-metal guide plate 1.

The bottom portion of the friction portion 21 on the transmission sheet 2 and the bottom portion of the guide plate slot 11 make contact with and are in sliding fit with each other, and meanwhile, the supporting portion 31 on the connecting sheet 3 does not make contact with the surface of the periphery of the non-metal guide plate 1, so that a first working state is formed, and this working state is an initial working state in which the saw chain is arranged on the non-metal guide plate 1. Because the non-metal guide plate 1 is made of a non-metal material, when the non-metal guide plate 1 is in frictional sliding fit with the friction portion 21, the bottom portion of the guide plate slot 11 of the non-metal guide plate 1 generates friction loss with the friction portion 21 at the bottom portion of the transmission sheet 2, so that the bottom portion of the guide plate slot 11 of the non-metal guide plate 1 becomes deeper.

The chainsaw assembly operates continuously in the first working state until the slot bottom of the guide plate slot 11 of the non-metal guide plate 1 is worn to a certain extent, and then the transmission sheet 2 sinks and drives the supporting portion 31 on the connecting sheet 3 to lean against a surface of the non-metal guide plate 1 to be in sliding fit with the surface of the non-metal guide plate 1. At this time, the chainsaw assembly enters a second working state, and in the second working state, the friction portion 21 still makes contact with and is in sliding fit with the bottom portion of the guide plate slot 11. Meanwhile, the supporting portion 31 on the bottom portion of the connecting sheet 3 is in sliding fit with the surface of the periphery of the non-metal guide plate 1. Because the connecting sheet 3 is arranged on two sides of transmission sheets 2, and the supporting portions 31 on two sides of the connecting sheet 3 are both in sliding fit with the surface of the periphery of the non-metal guide plate 1, in the second working state, a three-side stress may be formed, and a force between the saw chain and the non-metal guide plate 1 is shared by three sides, so that the force is borne by the three sides respectively, thus further reducing a sliding friction force between the friction portion 21 at the bottom portion of the transmission sheet 2 and the bottom portion of the guide plate slot 11. Therefore, the service life of a part between the transmission sheet 2 and the guide plate slot 11 may be longer, and the service life of the chainsaw assembly can be prolonged through the above two working states.

In order to avoid the situation that, in the second working state, because of too fast friction between the friction portion 21 at the bottom portion of the transmission sheet 2 and the slot bottom of the guide plate slot 11, only the supporting portion 31 on the bottom portion of the connecting sheet 3 makes contact with the surface of the periphery of the non-metal guide plate 1, while the friction portion 21 does not make contact with the slot bottom surface of the guide plate slot 11, A scraper 32 is arranged on the connecting sheet 3, and the arrangement of the scraper 32 aims to quickly scrape off the surface of the periphery of the non-metal guide plate 1, so that the friction portion 21 at the bottom portion of the transmission sheet 2 can sink to be in frictional sliding fit with the slot bottom of the guide plate slot 11. The connecting sheet 3 has a specific structure that the connecting sheet 3 is arranged in a structure of full central symmetry, and is in left-right and up-down consistency, wherein each lower edge is provided with a concave arc, which means that the supporting portion 31 is provided with a concave arc. The scraper 32 is arranged on an arc surface of the concave arc. On the saw chain, the scraper 32 is arranged on the supporting portion 31 on at least one connecting sheet 31. Therefore, the connecting sheet 3 comprises two structures, one is the connecting sheet 3 with the scrapper 32, and the other is the connecting sheet 3 without the scraper 32.

In actual production and mounting, a depth of the guide plate slot 11 may be 3.16 mm, the gap 6 between the supporting portion 31 on the bottom portion of the connecting sheet 3 and the surface of the non-metal guide plate 1 may be 0.51 mm, and the radius R of the chamfers at two ends of the friction portion 21 at the bottom portion of the transmission sheet 2 may be 1.00 mm.

In order to control a depth of each cutting by the blade 4 in actual working of the chainsaw assembly, a limiting block 22 protruding upwards is arranged at a top end of the transmission sheet 2, and a height of the limiting block 22 is lower than a height of the blade 4. Specifically, a highest point of the limiting block 22 in a vertical height is lower than a height of a cutting edge of the blade 4. It should be noted that the transmission sheet 2 may comprise two structures, wherein a first transmission sheet 2 is not provided with the limiting block 22 above, and a second transmission sheet 2 is provided with the limiting block 22 above. The mounted saw chain also comprises two solutions, wherein, in a first saw chain, all transmission sheets 2 are provided with the limiting block 22, and in a second saw chain, the limiting block 22 protruding upwards is arranged at a top end of any transmission sheet 2 connected with the same connecting sheet 3, which means that one of two transmission sheets 2 connected with the same connecting sheet 3 is the transmission sheet 2 provided with the limiting block 22, and the other transmission sheet is not provided with the limiting block 22. Because the limiting block 22 protruding upwards is arranged on the transmission sheet 2, firstly, a production procedure needs to be added, secondly, a production difficulty is increased, and thirdly, a manufacturing cost is increased, and in this solution, one of two transmission sheets 2 connected with the same connecting sheet 3 is provided with the limiting block 22, so that a manufacturing cost can be reduced, and it is unnecessary to arrange one limiting block 22 protruding upwards on each transmission sheet 2. During production, it is only necessary to produce a half of transmission sheets 2 provided with the limiting block.

It should be noted that, in actual mounting, two transmission sheets 2 are connected by the connecting sheet 3, and the connecting sheet 3 is connected with two sides of the transmission sheets 2, and meanwhile, the transmission sheet 2 and the connecting sheet 3 are connected by a chain shaft. The blade 4 comprises a left blade 4 and a right blade 4, and the left blade 4 and the right blade 4 are alternately arranged on two sides of the transmission sheets 2. It should be noted that the left blade 4 and the right blade 4 are not continuously arranged, and the left blade 4 and the right blade 4 are alternately arranged and separated by at least one connecting sheet 3. In actual mounting, a chain shaft hole 5 is arranged in a connecting portion of the transmission sheet 2, and the chain shafts are connected between the transmission sheet 2 and the connecting sheet 3, and between the transmission sheet 2 and the blade 4.

### Second Embodiment

This embodiment is different from First embodiment in that: in actual production and mounting, a depth of the guide plate slot 11 may be 3.16 mm, the gap 6 between the supporting portion 31 on the bottom portion of the connecting sheet 3 and the surface of the non-metal guide plate 1 may be 0.1 mm, and the radius R of the chamfers at two ends of the friction portion 21 at the bottom portion of the transmission sheet 2 may be 0.1 mm.

### Third Embodiment

This embodiment is different from First embodiment in that: in actual production and mounting, a depth of the guide plate slot 11 may be 3.16 mm, the gap 6 between the supporting portion 31 on the bottom portion of the connecting sheet 3 and the surface of the non-metal guide plate 1 may be 1 mm, and the radius R of the chamfers at two ends of the friction portion 21 at the bottom portion of the transmission sheet 2 may be 10 mm.

For the selection of the guide plate in each embodiment, the guide plate is made of a non-metal composite material, and the composite material needs to have the properties of high temperature resistance and wear resistance. Compared with a guide plate made of a traditional metal material, the non-metal guide plate in the present application is made of the composite material, the composite material is composed of the following raw materials in parts by weight: 40 to 70 parts of matrix resin, 20 to 40 parts of reinforced fiber, 5 to 15 parts of wear-resistant material and 0.5 to 1.5 parts of processing agent; wherein, the matrix resin is one or a combination of several of PEEK, PA66, PPA and PPS; the reinforced fiber is one or more of a carbon fiber, a glass fiber, an aramid fiber, a mineral fiber, and the like; the wear-resistant material comprises one or more of PTFE, an aramid fiber, molybdenum disulfide, graphite, ultra-high molecular weight polyethylene, a PBO fiber and silicone; a heat-conducting filler comprises metal powder or a metal fiber; and the processing agent comprises an anti-oxidant, a lubricant, a stabilizer, and the like.

### Formulas of Non-Metal Guide Plate:

Formula 1:54 parts of PEEK, 20 parts of carbon fiber, 10 parts of PTFE, 5 parts of graphite, 10 parts of metallic copper powder, 0.2 part of anti-oxidant 168, 0.2 part of anti-oxidant 1098, 0.3 part of silicone powder as a lubricant, and 0.3 part of H3336 as a thermal aging agent. The above raw materials are weighed in proportion, mixed by a high-speed mixer for 5 minutes to 10 minutes for full and uniform mixing, added with the carbon fiber through side feeding, and then extruded and granulated by a twin-screw extruder to prepare the wear-resistant material at an extrusion temperature of 310° C. to 360° C.

Formula 2:54 parts of PEEK, 30 parts of glass fiber, 5 parts of aramid fiber, 10 parts of stainless steel fiber, 5 parts of graphite, 0.2 part of anti-oxidant 168, 0.2 part of anti-oxidant 1098, and 0.3 part of silicone powder as a lubricant. The above raw materials are weighed in proportion, mixed by a high-speed mixer for 5 minutes to 10 minutes for full and uniform mixing, added with the glass fiber through side feeding, and then extruded and granulated by a twin-screw extruder to prepare the wear-resistant material at an extrusion temperature of 310° C. to 360° C.

Formula 3:55 parts of PEEK, 20 parts of carbon fiber, 5 parts of PBO fiber, 10 parts of PTFE, 5 parts of graphite, 5 parts of molybdenum disulfide, 0.2 part of anti-oxidant 168, and 0.2 part of anti-oxidant 1098. The above raw materials are weighed in proportion, mixed by a high-speed mixer for 5 minutes to 10 minutes for full and uniform mixing, added with the carbon fiber through side feeding, and then extruded and granulated by a twin-screw extruder to prepare the wear-resistant material at an extrusion temperature of 310° C. to 360° C.

Formula 4:50 parts of PEEK, 30 parts of glass fiber, 10 parts of molybdenum disulfide, 5 parts of silicone master batch, 5 parts of graphite, 0.2 part of anti-oxidant 168, and 0.2 part of anti-oxidant 1098. The above raw materials are weighed in proportion, mixed by a high-speed mixer for 5 minutes to 10 minutes for full and uniform mixing, added with the glass fiber through side feeding, and then extruded and granulated by a twin-screw extruder to prepare the wear-resistant material at an extrusion temperature of 310° C. to 360° C.

Comparative formula 1:60 parts of PEEK, 40 parts of glass fiber, 0.2 part of anti-oxidant 168, and 0.2 part of anti-oxidant 1098. The above raw materials are weighed in proportion, mixed by a high-speed mixer for 5 minutes to 10 minutes for full and uniform mixing, added with the glass fiber through side feeding, and then extruded and granulated by a twin-screw extruder to prepare the wear-resistant material at an extrusion temperature of 310° C. to 360° C.

Properties of the high-strength and wear-resistant composite materials prepared in Embodiments 1 to 4 are tested, and test data are as follows:

| | | Test result | | | | |
|---|---|---|---|---|---|---|
| | Test | Formula | Formula | Formula | Formula | Comparative |
| Test item | method | 1 | 2 | 3 | 4 | formula 1 |
| Tensile strength, MPa | ISO 527 | 220 | 190 | 230 | 210 | 270 |
| Bending strength, MPa | ISO 178 | 250 | 225 | 275 | 240 | 300 |
| Notch impact strength, | ISO 180 | 7.5 | 5.5 | 8.0 | 8.5 | 9.5 |
| KJ · m−2 | | | | | | |
| Friction coefficient | GB/T | 0.21 | 0.28 | 0.15 | 0.22 | 0.35 |
| Wearing capacity | 3960 | 2.2 | 5.8 | 1.5 | 2.5 | 12.0 |
| Heat conductivity coefficient | ASTM | 1.2 | 1.0 | 0.33 | 0.21 | 0.15 |
| | D5470 | | | | | |

The above embodiments are used for describing the present invention, and are not intended to limit the present invention, and any solution after simple transformation of the present invention belongs to the scope of protection of the present invention.

We claim:

1. A chainsaw assembly, comprising a guide plate and a saw chain, wherein:
the saw chain is arranged on the guide plate to rotate around a periphery of the guide plate for cutting; the saw chain comprises a transmission sheet and a connecting sheet which are sequentially and rotationally connected end-to-end, and a blade located on two sides of transmission sheets, two transmission sheets are connected by the connecting sheet located on two sides of the two transmission sheets, and a friction portion in sliding fit with a slot bottom of a guide plate slot is arranged at a bottom portion of the transmission sheet;
the guide plate is a non-metal guide plate; and the transmission sheet is inserted into the guide plate slot of the non-metal guide plate, and the friction portion at the bottom portion of the transmission sheet makes contact with and is in sliding fit with a bottom portion of the guide plate slot of the non-metal guide plate;
a supporting portion is arranged on the connecting sheet, the supporting portion is suspended above the non-metal guide plate, and a gap is left between the supporting portion on the connecting sheet and a surface of the non-metal guide plate during mounting; and
after the bottom portion of the guide plate slot of the non-metal guide plate generates friction loss with the friction portion at the bottom portion of the transmission sheet, the transmission sheet sinks and drives the supporting portion on the connecting sheet to lean against the surface of the non-metal guide plate to be in sliding fit with the surface of the non-metal guide plate.

2. The chainsaw assembly according to claim 1, wherein a contact surface between the friction portion and a slot bottom surface of the guide plate slot of the non-metal guide plate is a plane or an arc surface.

3. The chainsaw assembly according to claim 1, wherein chamfers are respectively arranged at two ends of the friction portion on the transmission sheet, and a radius of the chamfer is 0.1 mm to 10 mm.

4. The chainsaw assembly according to claim 1, wherein a limiting block protruding upwards is arranged at a top end of the transmission sheet, and a height of the limiting block is lower than a height of the blade.

5. The chainsaw assembly according to claim 1, wherein a limiting block protruding upwards is arranged at a top end of any transmission sheet connected with the same connecting sheet, and a height of the limiting block is lower than a height of the blade.

6. The chainsaw assembly according to claim 1, wherein a scraper is arranged on the supporting portion on at least one connecting sheet.

7. The chainsaw assembly according to claim 6, wherein the connecting sheet is arranged in a structure of full central symmetry, and is in left-right and up-down consistency, wherein each lower edge is provided with a concave arc, and the scraper is arranged on an arc surface of the concave arc.

8. The chainsaw assembly according to claim 1, wherein a distance between the connecting sheet and the surface of the non-metal guide plate is 0 to 1 mm; and a depth of the guide plate slot is 3.16 mm.
